(19) United States
(12) Patent Application Publication
(10) Pub. No.: US 2022/0083023 A1
(43) Pub. Date: Mar. 17, 2022

(54) ORIENTATION BASED 3D MODEL SECTION THICKNESS DETERMINATIONS

(71) Applicant: Hewlett-Packard Development Company, L.P., Spring, TX (US)

(72) Inventors: Matthew A. Shepherd, Vancouver, WA (US); Vanessa Verzwyvelt, Vancouver, WA (US); Jacob Wright, San Diego, CA (US); Xin Cheng, Vancouver, WA (US); Dennis J. Schissler, San Diego, CA (US); Morgan T. Schramm, Vancouver, WA (US)

(73) Assignee: Hewlett-Packard Development Company, L.P., Spring, TX (US)

(21) Appl. No.: 17/419,032

(22) PCT Filed: May 3, 2019
(86) PCT No.: PCT/US2019/030732

§ 371 Date: Jun. 28, 2021

(51) Int. Cl. G05B 19/4099

(52) U.S. Cl. CPC G05B 19/4099; G05B 2219/49023

(57) ABSTRACT

According to examples, an apparatus may include a processor and a memory on which are stored machine-readable instructions that when executed by the processor, may cause the processor to identify a first orientation of a first surface portion of a three-dimensional (3D) model. The instructions may also cause the processor to, based on the identified first orientation of the first surface portion, determine a first thickness of a first section of a first geological region of the 3D model, the first section being adjacent to the first surface portion, in which a plurality of different orientations of 3D model surface portions are correlated to a plurality of different thicknesses. The instructions may further cause the processor to define the first section of the first geological region to have the determined first thickness.

### BACKGROUND

In three-dimensional (3D) printing, an additive printing process may be used to make three-dimensional solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat and/or a chemical binder.

### BRIEF DESCRIPTION OF THE DRAWINGS

Features of the present disclosure are illustrated by way of example and are not limited in the following figure(s), in which like numerals indicate like elements, in which:

FIG. 1 shows a block diagram of an example apparatus that may determine a first thickness for a first section of a first geologic region in a 3D model based on an orientation of a first surface portion of the first section;

FIG. 2 shows a diagram of an example 3D fabrication system in which the apparatus depicted in FIG. 1 may be implemented;

FIGS. 3A and 3B, respectively, depict cross-sectional views of example 3D models that may be fabricated to include different thicknesses in multiple sections of geological regions of the 3D models;

FIG. 4 depicts a block diagram of an example apparatus that may select a first thickness for a first section of a 3D model based on an orientation of a first surface portion of the first section;

FIGS. 5A and 5B, respectively, show a diagram of a plane corresponding to a surface portion and a normal angle to the surface portion and a diagram for use in selecting a thickness for a section adjacent to the surface portion;

FIG. 6 shows a flow diagram of an example method for determining depths for corresponding sections of face portions of a 3D model based on orientations of the face portions of the 3D model in which the sections are located; and

FIG. 7 shows a block diagram of an example computer readable medium that may have stored thereon machine readable instructions that when executed by a processor, may cause the processor to determine thicknesses for sections of a geological region of a 3D model based on the orientations of surface portions adjacent to the sections.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In some types of 3D fabrication systems, 3D parts may be fabricated to include multiple concentric geological regions as different geological regions of the 3D parts may perform different functions with respect to the 3D parts. For instance, an interior or core region may not be visible and thus, colorant agents may not be applied to build material particles (which are also referenced herein as “particles”) that are to form the core region. Instead, agents that may cause the particles that are to form the core region to join, fuse, bind, or the like, together may be applied to those particles. These agents may include, for instance, coalescing agents, fusing agents, and/or the like. In contrast, an exterior or shell region that surrounds the core region may be visible and thus, a colorant agent and, in some instances, a coalescing agent, may be applied to the particles that are to form the shell region. Some 3D parts may be fabricated with additional regions that may also be fabricated using different agent formulations with respect to the core region and the shell region.

In some types of 3D fabrication systems, such as those in which the 3D parts are fabricated through application of agents and energy onto successive layers of build material particles, thermal properties may differ for those particles located on lower ones of the layers from those particles located on higher ones of the layers. That is, for instance, the particles located on the lower ones of the layers may attain lower temperatures than the particles located on the higher ones of the layers due to, for instance, thermal bleed across the previously formed layers. In some instances, the disparity in temperatures may result in the 3D parts exhibiting anisotropies in optical color and/or mechanical properties depending upon the directions that surfaces of the 3D parts face. For instance, some 3D fabrication systems may produce different colors on the top surface of a 3D part compared to the bottom, or sides, even though the same amounts, e.g., volumes, of agents are used to print each of the bottom, side, and top surfaces.

Disclosed herein are apparatuses, methods, and computer readable media that may determine thicknesses for various sections of a first geological region of a 3D model based on the orientations of exterior surface portions of the sections, such that the sections of the first geological region, e.g., the shell region, of a 3D part may be fabricated to have the determined thicknesses. That is, for instance, an orientation of a first surface portion of a first section of the first geological region may be identified, and based on the identified orientation of the first surface portion, a determination may be made as to a first thickness at which the first section is to be defined. The first section may be adjacent to the first surface portion, e.g., may extend from the first surface portion to an interface of the first geological region to a second geological region. In addition, the first section of the first geological region may be defined to have the determined first thickness. Moreover, a second thickness for a second section of the first geological region that is adjacent to a second surface portion of the first geological region may be determined based on the orientation of the second surface portion. The thicknesses of additional sections of the first geological region as well as thicknesses of sections of additional geological regions of the 3D model may be determined through a similar process.

According to examples, each of a plurality of orientations of surface portions may correspond to non-uniform thicknesses, or equivalently, multiple depths. The correlations between the plurality of surface portion orientations and the thicknesses of region sections may correspond to a particular region, e.g., a shell region. In addition, multiple correlations may be determined for different regions of the 3D model including, for instance, a core region, a mantle region, an atmosphere region, and/or the like. In this regard, each of the multiple regions may include respective correlations between surface/interface portion orientations and section thicknesses. Moreover, multiple correlations may be or may have been determined for multiple types of build material particles, multiple types of agents, multiple fabrication processes, etc.

According to examples, the correlations may be determined for finite sets of orientations, e.g., for each degree across 360 degrees, for each degree across 180 degrees, over a set interval of degrees over 180 degrees, or the like. By way of example, the set of orientations may include a set of angles that extend from −90 degrees to +90 degrees from a horizontal line. In any regard, the orientations may be defined from a reference orientation, such as a horizontal line, a vertical line, a diagonal line, or any line therebetween. The correlations may also be applicable to orientations that extend in any direction in a 3D space. Thus, for instance, a correlation for an orientation that extends at a first angle from a horizontal reference orientation along a first vertical plane may also be applicable for an orientation that extends at the first angle from the horizontal reference orientation along a second vertical plane. In otherwords, the correlations may be applicable in any orientation across a 3D polar coordinate space.

The various correlations between surface/interface portion orientations and section thicknesses discussed herein may identify the section thicknesses that may cause a 3D part fabricated based on the 3D model to have a consistent optical characteristic, a consistent mechanical property, both a consistent optical characteristic and a consistent mechanical property across the external surface portions, e.g., across the exterior of the shell region, of the 3D part. The various correlations discussed herein may be or may have been determined through testing, modeling, historical data, and/or the like, of various combinations of build material particles, agents, fabrication processes, and/or the like.

As discussed herein, the use of the same thicknesses across sections of a geologic region of a 3D part may result in anisotropies in color and/or mechanical properties on the surface portions of geologic region depending on the direction in which the surface portion faces. Through implementation of the features of the present disclosure, non-uniform thicknesses may be determined and defined for multiple sections of a geologic region of the 3D part, in which the non-uniform thicknesses are to improve an optical and/or mechanical property of the 3D part. For instance, fabrication of the 3D part with the non-uniform geologic region section thicknesses may result in greater accuracy and/or uniformity in optical properties and/or strength properties among the surface portions of the 3D part regardless of the directions in which surface portions face.

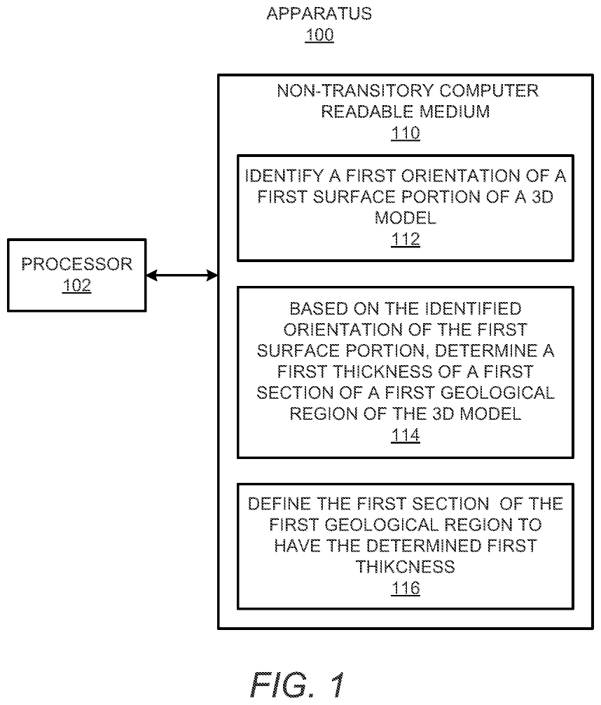

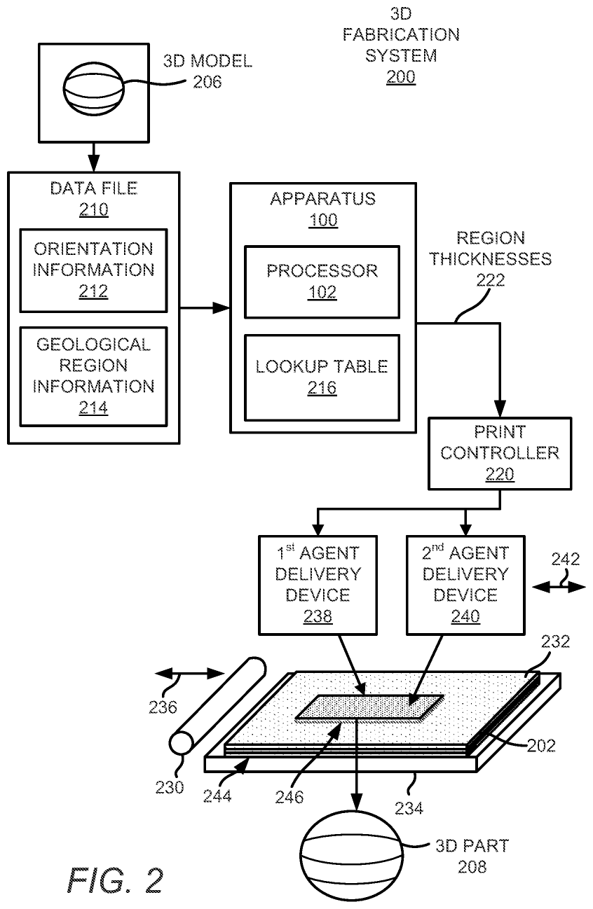

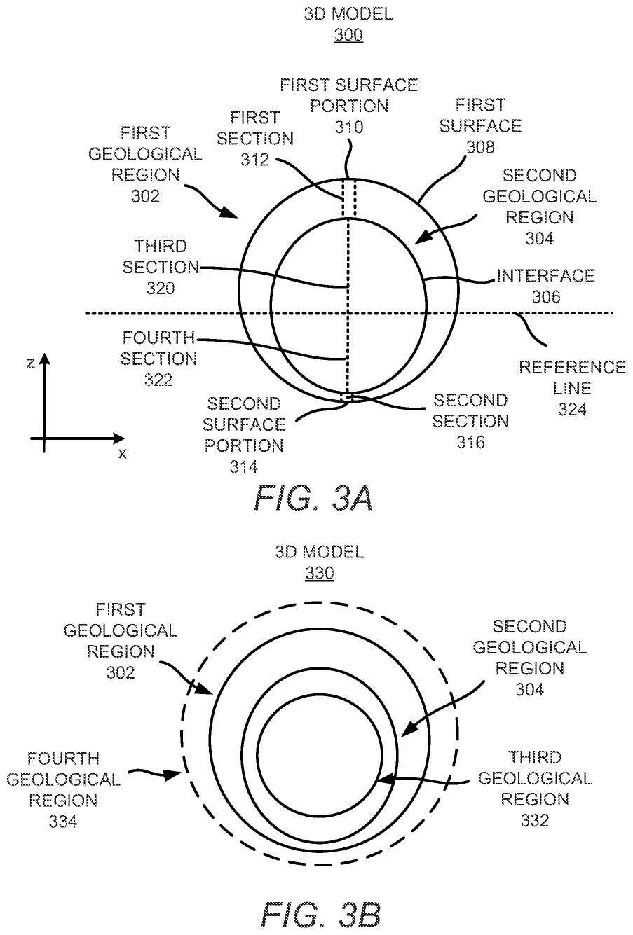

Reference is made first to FIGS. 1, 2, 3A, and 3B. FIG. 1 shows a block diagram of an example apparatus 100 that may determine a first thickness for a first section of a first geologic region in a 3D model based on an orientation of a first surface portion of the first section. The apparatus 100 may determine the first thickness at which the first section is to be defined, for instance, to mitigate anisotropy in surface portions of a 3D part with respect to each other. FIG. 2 shows a diagram of an example 3D fabrication system 200 in which the apparatus 100 depicted in FIG. 1 may be implemented. FIGS. 3A and 3B, respectively, depict cross-sectional views of example 3D models 300, 330 that may be fabricated to include non-uniform thicknesses in multiple sections of the geologic regions of the 3D models.

It should be understood that the example apparatus 100 depicted in FIG. 1, the example 3D fabrication system 200 depicted in FIG. 2, and the example 3D models 300, 330 may include additional features and that some of the features described herein may be removed and/or modified without departing from the scopes of the apparatus 100, the 3D fabrication system 200, or the 3D models 300, 330.

The apparatus 100 may be a computing device, a tablet computer, a server computer, a smartphone, or the like. The apparatus 100 may alternatively be part of the 3D fabrication system 200, e.g., a CPU of the 3D fabrication system 200. Although the apparatus 100 is depicted as including a single processor 102, it should be understood that the apparatus 100 may include multiple processors, multiple cores, or the like, without departing from a scope of the apparatus 100.

The 3D fabrication system 200, which may also be termed a 3D printing system, a 3D fabricator, or the like, may be implemented to fabricate or equivalently, print, 3D parts through selective solidification of build material particles 202, which may also be termed particles 202 of build material. In some examples, the 3D fabrication system 200 may use agents to selectively bind and/or solidify the particles 202. In particular examples, the 3D fabrication system 200 may use fusing agents that increase the absorption of fusing energy to selectively fuse the particles 202 on which the agents are deposited. In addition, the 3D fabrication system 200 may use modifying agents, such as colorant agents to apply color to exterior sections of 3D parts. The modifying agents may be differently colored inks, such as inks having one of cyan, magenta, yellow, or black colors, although the 3D fabrication system 200 may use additional or other colored inks. The modifying agents may additionally or alternatively have other compositions that may affect other properties of the portion 204 of the 3D part 208 such as, conductivity, surface roughness, elasticity, translucency, and/or the like.

In some examples, fusing agents and modifying agents may be combined into combined agents, while in other examples, the fusing agents may be separate from the modifying agents. In any of these examples, some of the fusing agents may be mainly transparent, e.g., have a low tint, while other fusing agents may have a dark, e.g., black color.

According to one example, a suitable agent may be an ink-type formulation including carbon black, such as, for example, the agent formulation commercially known as V1Q60A “HP fusing agent” available from HP Inc. The carbon black agent may be used to fuse particles that form interiors, e.g., hidden core portions, of 3D parts, while agents having lighter colors and/or greater translucency may be used to fuse particles that form exteriors of the 3D parts. In one example, such an agent may additionally include an infra-red light absorber. In one example such agent may additionally include a near infra-red light absorber. In one example, such an agent may additionally include a visible light absorber. In one example, such an agent may additionally include a UV light absorber. Examples of agents including visible light enhancers are dye based colored ink and pigment based colored ink, such as inks commercially known as CE039A and CE042A available from HP Inc.

According to examples, the 3D fabrication system 200 may use a coalescing agent (or a fusing agent, or the like), that may be separate from the colorant agents. In these examples, the 3D fabrication system 200 may separately control the volumes at which the coalescing agent and the colorant agents may be applied onto the build material particles 202. According to examples, the 3D fabrication system 200 may additionally use a detailing agent that may reduce or impede coalescence, e.g., fusing, of build material particles 202 onto which the agent has been deposited and/or absorbed. In one example, the detailing agent may be a substantially transparent liquid. According to one example, a suitable type of such an agent may be a formulation commercially known as V1Q61A “HP detailing agent” available from HP Inc. The 3D fabrication system 200 may also separately control the volumes at which the detailing agent is applied.

The build material particles 202 may include any suitable material for use in forming 3D objects. The build material particles 202 may include, for instance, a polymer, a plastic, a ceramic, a nylon, a metal, combinations thereof, or the like, and may be in the form of a powder or a powder-like material. Additionally, the build material particles 202 may be formed to have dimensions, e.g., widths, diameters, or the like, that are generally between about 5 μm and about 100 μm. In other examples, the particles 202 may have dimensions that are generally between about 30 μm and about 60 μm. The particles 202 may have any of multiple shapes, for instance, as a result of larger particles being ground into smaller particles. In some examples, the particles 202 may be formed from, or may include, short fibers that may, for example, have been cut into short lengths from long strands or threads of material. In addition or in other examples, the particles 202 may be partially transparent or opaque. According to one example, a suitable build material may be PA12 build material commercially known as V1 R10A “HP PA12” available from HP Inc.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. The apparatus 100 may also include a non-transitory computer readable medium 110 that may have stored thereon machine readable instructions 112-116 (which may also be termed computer readable instructions) that the processor 102 may execute. The non-transitory computer readable medium 110 may be an electronic, magnetic, optical, or other physical storage device that includes or stores executable instructions, where the term “non-transitory” does not encompass transitory propagating signals. The non-transitory computer readable medium 110 may be, for example, Random Access memory (RAM), an Electrically Erasable Programmable Read-Only Memory (EEPROM), a storage device, an optical disc, and the like. The non-transitory computer readable medium 110 may also be referred to as a memory.

In some examples, instead of the non-transitory computer readable medium 110, the apparatus 100 may include hardware logic blocks that may perform functions similar to the instructions 112-116. In yet other examples, the apparatus 100 may include a combination of instructions and hardware logic blocks to implement or execute functions corresponding to the instructions 112-116. In any of these examples, the processor 102 may implement the hardware logic blocks and/or execute the instructions 112-116. As discussed herein, the apparatus 100 may also include additional instructions and/or hardware logic blocks such that the processor 102 may execute operations in addition to or in place of those discussed above with respect to FIG. 1.

As discussed herein, a 3D model 206 may be a data representation of a 3D part 208 to be fabricated. Particularly, for instance, a data file 210 may include information about the 3D model 206 that the processor 102 may access to determine printing parameters, e.g., geological region identifications, geological region section thicknesses, agent formulations, and/or the like, to be used in fabricating a 3D part 208. For instance, the data file 210 may include information pertaining to features of the 3D model 206, such as physical dimensions, orientation information 212 of surfaces, geological region information 214, color information, etc. The orientation information 212 may include, for instance, the orientations (e.g., angles from a reference plane or line) at which surfaces of the 3D model 206 extend.

As shown in FIG. 3A, a 3D model 300, which may correspond to a cross-sectional view frontal view of the 3D model 206 depicted in FIG. 2, may define a first geological region 302 and a second geological region 304. Although not explicitly shown, the first geological region 302 may completely surround the second geological region 304 such that the second geological region 304 is completely encased within the first geological region 302. In other words, the interface 306 between the first geological region 302 and the second geological region 304 may not be visible. In any regard, as discussed herein, the first geological region 302 may have different properties than the second geological region 304. That is, for instance, the first geological region 302 may have a first surface 308 that is visible whereas the second geological region 304 may not include any visible sections. Thus, for instance, agent formulations that are to be used to fabricate the first geological region 302 and the second geological region 304 may differ from each other. The agent formulations may define the amounts, e.g., volumes, drop numbers, locations of drops, etc., at which an agent is or multiple agents are to be applied onto respective layers of build material particles 202 to fabricate the geological regions of the 3D part 208. For instance, the agent formulation for the first geological region 302 may define the amounts that a modifying agent (e.g., a fusing agent), a colorant agent, and a coalescence modification agent (e.g., a detailing agent) are to be applied to fabricate a first geological region 302 of the 3D part 208. The agent formulation for the second geological region 304 may define the amounts that an agent including a fusing agent are to be applied to fabricate the second geological region 304 of the 3D part 208.

In any regard, the first geological region 302 may include a first surface portion 310 and a first section 312 that extends beneath and adjacent to the first surface portion 310. Particularly, the first section 312 may include a part of the first geological region 302 and extends between the first surface portion 310 and the interface 306 between the first geological region 302 and the second geological region 304. The size of the first surface portion 310 may be user-defined and/or may be set based on previous testing. In some examples, the size of the first surface portion 310 may be selected based on a desired level of accuracy, for instance, the size of the first surface portion 310 may be inversely proportional to the desired accuracy level, e.g., the size may be smaller for greater accuracy. In some examples, the first surface portion 310 may be a point. It should be understood that the 3D models 206, 300, 330 and the 3D part 208 depicted in FIGS. 2, 3A and 3B are merely examples provided for illustrative purposes and should thus not be construed as limiting the present disclosure in any respect.

With particular reference to FIGS. 1 and 3A, the processor 102 may fetch, decode, and execute the instructions 112 to identify an orientation of a first surface portion 310 of a first geological region 302 of a three-dimensional (3D) model 300. For instance, the processor 102 may determine the orientation of a first surface portion 310 from the orientation information 212. In some examples, the processor 102 may determine the orientation of the first surface portion 310 as a normal angle to a plane of the first surface portion 310 as discussed herein.

Although particular reference is made to the processor 102 identifying the orientation of the first surface portion 310, the processor 102 may identify the orientations of each of the surface portions of the first geological region 302 forming the 3D model 300. In this regard, the description of processes implemented with regard to the first surface portion 310 may equally be applicable to other surfaces/interfaces of the 3D model 300.

The processor 102 may fetch, decode, and execute the instructions 114 to, based on the identified first orientation of the first surface portion 310, determine a first thickness of the first section 312 of the first geological region 302. As discussed herein, the processor 102 may determine the first thickness such that the first surface portion 310 may be fabricated to have a color that accurately matches the color of other surface portions that may have the same or other orientations as the first surface portion 310. In addition, or alternatively, the processor 102 may determine the first thickness such that the first surface portion 310 has a desired surface property, a desired mechanical property, and/or the like. In other words, the processor 102 may determine the first thickness for the first section 312, as well as determine the thicknesses for other sections of the first geological region 302, to mitigate anisotropy among the surface portions of the first geological region 302. For instance, the processor 102 may determine the first thickness such that the first surface portion 310 may have a consistent optical characteristic, a consistent mechanical property, or both a consistent optical characteristic and a consistent mechanical property with respect to other surface portions of the 3D part 208.

For instance, the first surface portion 310 may have the same or similar color as surface portions having orientations that differ from the orientation of the first surface portion 310. Likewise, the first surface portion 310 may have the same or similar glossiness, translucency, surface finish, or the like, as the other surface portions. In addition, or alternatively, the first surface portion 310 may have the same or similar strength, rigidity, elasticity, or the like, as surface portions having orientations that differ from the orientation of the first surface portion 310.

According to examples, various correlations between surface portion orientations and section thicknesses that may result in the surface portions having various properties as discussed herein may be or may have been determined through testing, modeling, historical data, and/or the like, of various combinations of build material particles 202, agents, fabrication processes, and/or the like. In addition, the various correlations may be stored in a lookup table 216, which the processor 102 may access to determine, based on the identified first orientation of the first surface portion 310, the corresponding first thickness of the first section 312. Thus, for instance, the processor 102 may determine the first thickness, as well as other thicknesses, for various sections of the first geological region 302 from the lookup table 216. In addition, the lookup table 216, or other lookup tables, may include various correlations for other geological regions of the 3D model 206 as those correlations may differ from the correlations for the first geological region 302. In other examples, however, the processor 102 may determine the thicknesses of the first section 312 algorithmically without using the lookup table 216.

The processor 102 may fetch, decode, and execute the instructions 116 to define the first section 312 of the 3D model 300 to have the determined first thickness. That is, for instance, the processor 102 may define the set of instructions that the 3D fabrication system 200 is to use to fabricate the 3D part 208 to include an instruction to fabricate the first section 312 to have the determined first thickness.

According to examples, the processor 102 may also identify a second orientation of a second surface portion 314 of the first geological region 302. The processor 102 may identify the second surface portion 314 and the second orientation in any of the manners discussed above with respect to the first surface portion 310 and the first orientation. In addition, the processor 102 may, based on the identified second orientation of the second surface portion 314, determine a second thickness of a second section 316 of the 3D model 300. The processor 102 may determine the second thickness in any of the manners discussed above with respect to the determination of the first thickness. As shown in FIG. 3A, the second section 316 may be adjacent to the second surface portion 314 and the second thickness may be non-uniform with respect to the first thickness. Moreover, the processor 102 may define the second section 316 of the 3D model to have the second thickness, again in similar manners to those discussed above with respect to defining the first section 312 of the 3D model to have the first thickness.

According to examples, the processor 102 may identify a third section 320 of the second geological region 304 that is adjacent to the first section 312 and a fourth region of the second geological region 304 that is adjacent to the second section 316. In these examples, the processor 102 may identify a third thickness of the third section 320 based on the defined first thickness of the first section 312. In addition, the processor 102 may determine a fourth thickness of the fourth section 322 of the second geological region 304 based on the defined second thickness of the second section 316. That is, for instance, the processor 102 may determine the third and fourth thicknesses, as may be measured from a reference line 324, to be relatively longer or shorter than nominal thicknesses based on the first thickness and the second thickness. The thicknesses of the third and fourth sections may be determined as thicknesses that may result in the 3D part 208, and in some instances, the first geological region 302, to have desired and/or predefined optical and/or structural properties. In some examples, the thicknesses within the second geological region 304 may be modified based on the thicknesses within the first geological region 302 in instances in which the 3D model 300 may include more than two geological regions.

In some examples, instead of determining the third and fourth thicknesses from the first and second thicknesses, respectively, the processor 102 may determine the thicknesses of the sections forming the second geological region 304 from predefined correlations between orientations of portions of the interface 306 adjacent to the sections and thicknesses. Thus, for instance, in these examples, the processor 102 may determine the thicknesses of the sections forming the second geological region 304 from correlations identified in the lookup table 216. Again, the correlations may have been predefined such that the 3D part 208, and in some instances, the second geological region 304, may be fabricated to have desired and/or predefined optical and/or structural properties. In other examples, however, the processor 102 may determine the thicknesses algorithmically without using the lookup table 216.

An example of a 3D model 330 having more than two geological regions is depicted in FIG. 3B. The 3D model 330 is depicted as including the first geological region 302 and the second geological region 304. In this example, the first geological region 302 may be a shell region in that the first geological region 302 may be the outermost region of the 3D model 330 and the second geological region 304 may be a mantle region in that the second geological region 304 may not be the inner most region of the 3D model 330. Instead, the 3D model 330 may include a third geological region 332 that may form a core region of the 3D model 330. The 3D model 330 may also include a fourth geological region 334 that may be outside of and may encompass, in three dimensions, the first geological region 302. The fourth geological region 334 may denote an area around the first geological region 302 that may be defined to receive an agent or multiple agents to enhance the properties of the first geological region 302. For instance, the areas denoted by the fourth geological region 334 may receive a colorant agent having a similar color to the first geological region 302 and may, in some instances, receive detailing agent to prevent the build material particles 202 in that area from fusing with the build material particles 202 in the area to be formed into the first geological region 302. The fourth geological region 334 may thus not form part of the 3D model 330, but may receive agents during fabrication of the 3D part 308. For instance, the fourth geological region 334 my receive a colorant agent or multiple colorant agents similar to the first geological region 302 to cause the particles 202 in the fourth geological region 334 to have the same color as the particles 202 in the first geological region 302. The fourth geological region 334 may be a colored envelope surrounding the first geological region 302 to insulate the first geological region 302 from the outside particles 202, but to not adhere to the surface of the first geological region 302 According to examples, different agent formulations may be used for each of the geological regions 302, 304, 332, 334. In addition, different correlations between orientations and thicknesses may be defined for each or a plurality of the geological regions 302, 304, 332, 334.

As shown in FIG. 2, the 3D fabrication system 200 may include a print controller 220 that may control operations of components of the 3D fabrication system 200 to fabricate the 3D printed part 208. That is, the processor 102 may communicate the determined thicknesses 222 of the sections, e.g., the first section 312, the second section 316, etc., to the print controller 220. The processor 102 may also communicate other types of information, such as the agent formulations that are to be used to fabricate the geological regions of the 3D model 300, 330. The print controller 220 may control operations of the components based on the received information received from the processor 102 to fabricate the 3D part 208.

The 3D fabrication system 200 may include a spreader 230 that the print controller 220 may control to spread the build material particles 202 into a layer 232, e.g., through movement across a platform 234 as indicated by the arrow 236. As also shown in FIG. 2, the 3D fabrication system 200 may include a first agent delivery device 238 and a second agent delivery device 240, although additional agent delivery devices may also be included. The first agent delivery device 238 and the second agent delivery device 240 may be scanned in the direction denoted by the arrow 242, in a direction perpendicular to the arrow 242, and/or in other directions. In addition, or alternatively, the platform 234 on which the layers 232 are deposited may be scanned in directions with respect to the first agent delivery device 238 and the second agent delivery device 240. Although not shown, the 3D fabrication system 200 may include an energy source that may output energy onto the layer 232 as the energy source is scanned across the layer 232 as denoted by the arrow 242. The energy source may be a laser beam source, a heating lamp, or the like, that may apply energy onto the layer 232 and/or that may apply energy onto the selected area 244.

The 3D fabrication system 200 may include a build zone 244 within which the components of the 3D fabrication system 200 may solidify the build material particles 202 in a selected area 246 of the layer 232. The selected area 246 of a layer 232 may correspond to an area of the 3D part 208 being fabricated in multiple layers 232 of the build material particles 202. The 3D fabrication system 200 may fabricate the 3D printed part 208 through selective deposition of a first agent and a second agent on respective layers 232 of the build material particles 202. The first agent may be an agent that is to modify a mechanical property of the build material particles 202 and the second agent may be an agent that is to modify an optical property of the build material particles 202. Although not shown, the 3D fabrication system 200 may include an additional agent delivery device that may deliver a similar type of agent, another type of agent, or the combinations thereof. Thus, for instance, the print controller 220 may control the agent delivery devices 238, 240 to selectively deposit the first agent, multiple second agents, and in some instances, a third agent (e.g., a detailing agent), onto respective layers 232 according to the determined agent formulations to fabricate the 3D printed part 208. In any regard, the print controller 220 may control the agent delivery devices 238, 240 to fabricate the geological regions 302, 304 of the 3D part 208 to have the defined thicknesses.

A first type of agent, such as a fusing agent, may enhance absorption of energy to cause the build material particles 202 upon which the agent has been deposited to melt. The first type of agent may be applied to the build material particles 202 prior to application of energy onto the build material particles 202. In other examples, the first agent delivery device 238 may deliver a binding agent, such as an adhesive that may bind build material particles 202 upon which the binding agent is deposited.

As shown in FIG. 2, the fabrication system 200 may fabricate a lower section of the 3D part 208 first and may build up the remaining sections of the 3D part 208 in successive layers 232 of the build material particles 202. In one regard, surface portions that face downward in FIG. 3A, which may correspond to the lower portion of the 3D part 208, may be formed on particles 202 that may not have been previously been heated. As a result, the bottom facing surface portions, e.g., the second section 316, may be formed on relatively cooler particles than the upward facing surface portions, e.g., the first section 312.

According to examples, and as shown in FIG. 3A, the second section 316 may have a relatively smaller thickness than the first section 312 such that, for instance, a bottom portion of the second geological region 304 may start to be formed in lower layers 232 of particles 202. As the second geological region 304 may be in an interior section and may not receive a colorant agent, which may have a cooling effect, the second geological region 304 may have a greater energy absorptivity than the first geological region 302 and may thus have a higher temperature than the first geological region 302. As a result, the temperature of the second section 316 may be increased by the formation of the second geological region 304, which may aid in the coalescence of the particles 202 in the second section 316. In contrast, the first section 312 may have a relatively larger thickness than the second section 316 because heat from the previously formed particle layers 232 of the second geological region 304 may radiate into the first section 312 and thus, the particles 202 in the first section 312 may become overheated. In one regard, by increasing the thickness of the first section 312, there may be a greater number of particle layers 232 that may absorb the heat radiated from the second geological region 304, which may reduce overheating of the particles 202 near the first surface 308 at the first surface portion 310.

The thicknesses of the sections of the first geological region 302 at the sides of the 3D model 300 may be determined to, for instance, compensate for agent deposition alignment issues. For instance, increasing the thicknesses of the sections at the sides of the first geological region 302, errors associated with agent deposition alignment issues may be distributed over a larger volume, which may reduce an overall effect of the agent deposition alignment issues.

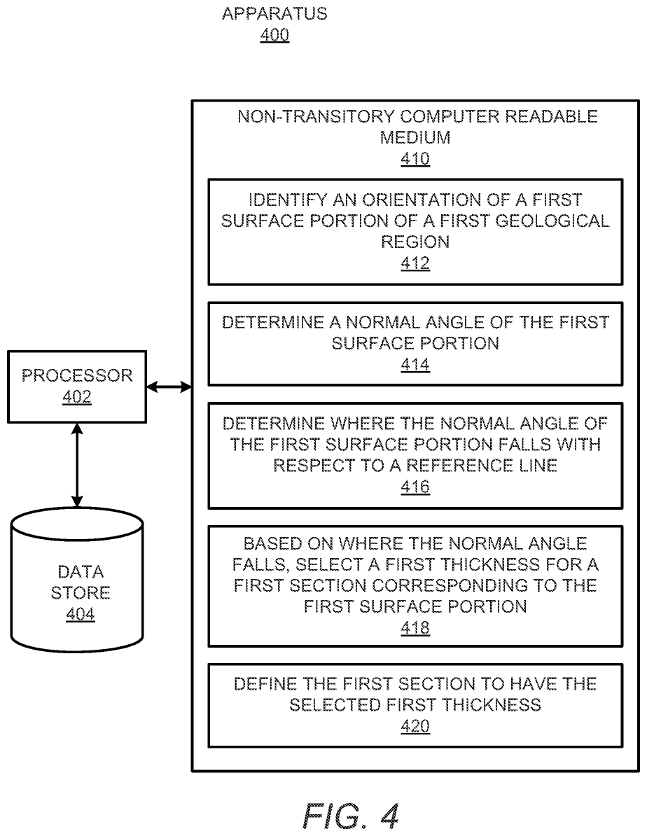

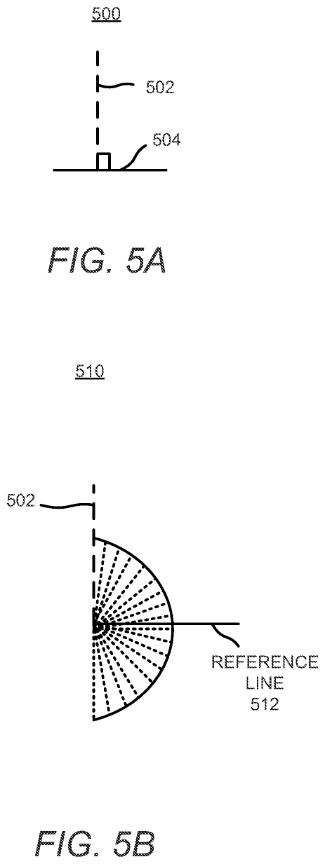

Turning now to FIG. 4, there is shown a block diagram of an example apparatus 400 that may select a first thickness for a first section 312 of a 3D model 300 based on an orientation of a first surface portion 210 of the first section 312. The apparatus 400 may determine the first thickness for the first section 312, for instance, to mitigate anisotropy in surface portions of a 3D part 208 corresponding to the 3D model 300. It should be understood that the example apparatus 400 depicted in FIG. 4 may include additional features and that some of the features described herein may be removed and/or modified without departing from the scope of the apparatus 400. The description of the apparatus 400 is made with respect to the 3D fabrication system 200 shown in FIG. 2, the 3D model 300 depicted in FIG. 3A, as well as the diagrams 500 and 510 respectively depicted in FIGS. 5A and 5B.

The apparatus 400 may be equivalent to the apparatus 100 depicted in FIG. 1. As shown in FIG. 4, the apparatus 400 may include a processor 402 that may control operations of the apparatus 400 and a non-transitory computer readable medium 410 that may have stored thereon machine readable instructions 412-420 (which may also be termed computer readable instructions) that the processor 402 may execute. The processor 402 and the non-transitory computer readable medium 410 may be similar to the processor 102 and the non-transitory computer readable medium 110 depicted in FIG. 1.

The processor 402 may fetch, decode, and execute the instructions 412 to identify an orientation of a first surface portion 310 of a 3D model 300. The processor 402 may identify the orientation of the first surface portion 310 as discussed above with respect to the apparatus 100. For instance, the processor 302 may identify the orientation of the first surface portion 310 from the orientation information 212 included in the data file 210.

The processor 402 may fetch, decode, and execute the instructions 414 to determine a normal angle 502 of the first surface portion 310. An example of a plane 504 corresponding to the first surface portion 310 and an angle 502 that is normal to the plane 504 at which the first surface portion 310 extends is depicted in the diagram 500 of FIG. 5A.

The processor 402 may fetch, decode, and execute the instructions 416 to determine where the normal angle 502 falls with respect to a reference line 512. As shown in the diagram 510 of FIG. 5B, the reference line 512 may extend horizontally. In addition, the normal angle 502 may fall approximately 90 degrees from the reference line 512. This may denote that the first surface portion 310 extends directly upwards. The processor 402 may also fetch, decode, and execute the instructions 418 to, based on where the normal angle 502 falls with respect to the reference line 512, select a first thickness for the first section 312. The first section 312 may be the portion of the first geological region 302 that is immediately adjacent to the first surface portion 310 as discussed herein. The processor 302 may select the first thickness from predefined correlations between surface orientations and thicknesses, which may, for instance, be stored in a data store 404 as also discussed herein.

According to examples, various thicknesses for the first geological region 302 may be correlated to various angles as represented by the dotted lines in the diagram 510. That is, a particular thickness may be correlated to each of the angles between −90 degrees and +90 degrees from the reference line 512. In addition, angles of the surface portions facing opposite directions from those shown in FIG. 5B may be equivalent to their counterpart angles. The thicknesses corresponding to the various angles may have been determined such that the first geological region 302 may be fabricated to achieve desired properties as discussed herein.

The processor 402 may fetch, decode, and execute the instructions 420 to define the first section 312 to have the selected first thickness. That is, for instance, the processor 402 may define the set of instructions that the 3D fabrication system 200 is to use to fabricate the 3D part 208 to include an instruction to fabricate the first section 312 to have the selected first thickness. The processor 402 may also communicate the defined first section 312 thickness to the print controller 220.

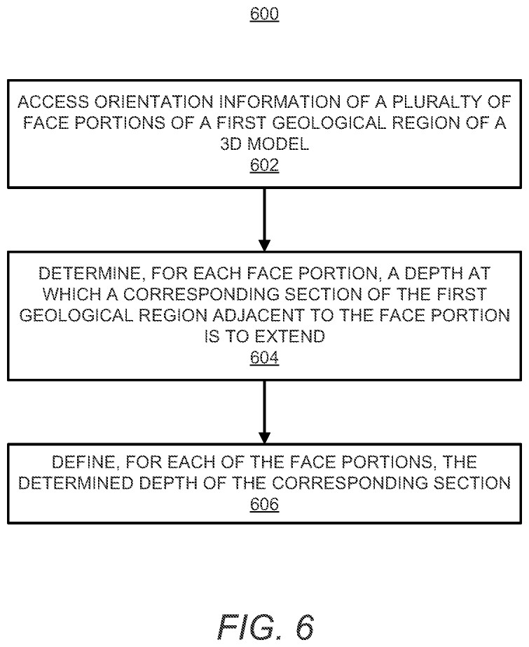

Various manners in which the processor 102, 302 may operate are discussed in greater detail with respect to the method 600 depicted in FIG. 6. Particularly, FIG. 6 depicts a flow diagram of an example method 600 for determining depths for corresponding sections of face portions of a 3D model based on orientations of the face portions of the 3D model in which the sections are located. It should be understood that the method 600 depicted in FIG. 6 may include additional operations and that some of the operations described therein may be removed and/or modified without departing from the scope of the method 600. The description of the method 600 is made with reference to the features depicted in FIGS. 1-5B for purposes of illustration.

At block 602, the processor 102, 402 may access, e.g., obtain, determine, and/or the like, orientation information 212 of a plurality of face portions 310, 314 of a first geological region 302 of a three-dimensional (3D) model 300. The face portions 310, 314 may be equivalent to the surface portions 310, 314 discussed herein. According to examples, the processor 102, 402 may identify orientations of the plurality of face portions 310, 314 from the orientation information 212 for the first geological region 302 as normal angles from respective angles at which the plurality of faces extend. In other examples, the processor 102, 402 may receive the orientations of the plurality of face portions 310, 314.

At block 604, based on the orientation information 212, the processor 102, 402 may determine, for each face portion 310, 314 of the plurality of face portions of the first geological region 302, a depth at which a corresponding section 312, 316 of the first geological region 302 adjacent to the face portion 310, 314 is to extend from an interface 306 with a second geological region 304 of the 3D model 300. As discussed herein, a plurality of the corresponding sections 312, 316 may be determined to have non-uniform depths with respect to each other. The depths may be equivalent to the thicknesses discussed herein. In any regard, the processor 102, 402 may determine the depths for each of the corresponding sections 312, 316 in any of the manners discussed above.

According to examples, the processor 102, 402 may determine the depths at which sections of the first geological region 302 corresponding to the plurality of face portions 310, 314 are to extend from predetermined correlations between a plurality of different orientations of 3D model face portions and a plurality of depths. For instance, the predetermined correlations may be selected to cause a 3D part 208 fabricated based on the 3D model 300 to have a consistent optical characteristic, a consistent mechanical property, or both a consistent optical characteristic and a consistent mechanical property across the plurality of face portions.

According to examples, the processor 102, 402 may also identify, from the data file 210, a second geological region 304 of the 3D model 300, the first geological region 302 completely surrounding the second geological region 304. The first geological region 302 and the second geological region 304 correspond to portions of a 3D part 208 to be fabricated based on the 3D model 206 and the first geological region 302 may be fabricated using a different agent formulation than the second geological region 304. In addition, the processor 102, 402 may determine the depths of the first geological region 302 as distances from an interface 306 between the first geological region 302 and the second geological region 304.

At block 606, the processor 102, 402 may define, for each of the face portions 310, 314, the determined depth of the corresponding section 312, 316. Again, the processor 102, 402 may define the determined depth of the corresponding section 312, 316 as discussed herein.

According to examples, the processor 102, 402 may store the determined depths for the face portions 310, 314 in the data store 404. In addition, or alternatively, the processor 102, 402 may communicate the determined depths to the print controller 220 of the 3D fabrication system 200 and the print controller 220 may control components, e.g., the agent delivery devices 238, 240, to fabricate a 3D part 208 to have a first geological region 302 having sections with the determined depths, among other regions.

Some or all of the operations set forth in the method 600 may be included as utilities, programs, or subprograms, in any desired computer accessible medium. In addition, the method 600 may be embodied by computer programs, which may exist in a variety of forms. For example, the method 600 may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

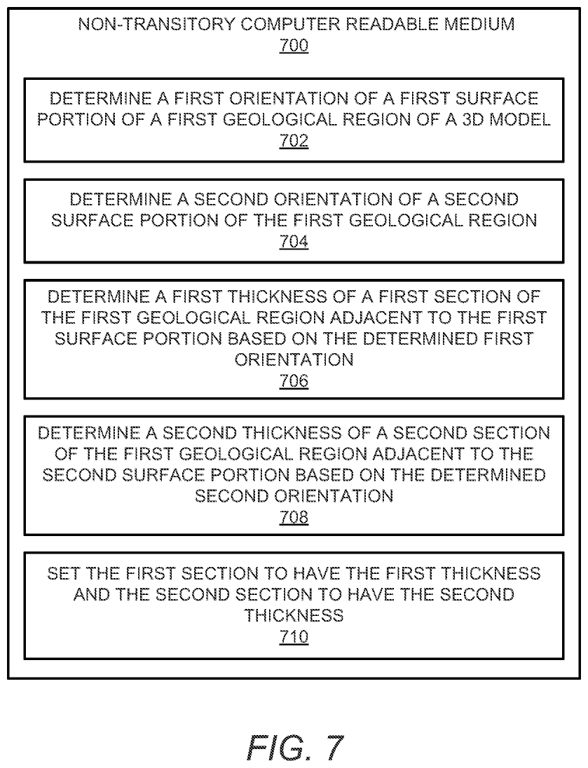

Turning now to FIG. 7, there is shown a block diagram of an example computer readable medium 700 that may have stored thereon machine readable instructions that when executed by a processor, may cause the processor to determine thicknesses for sections of a geological region of a 3D model based on the orientations of surface portions adjacent to the sections. It should be understood that the computer readable medium 700 depicted in FIG. 7 may include additional instructions and that some of the instructions described herein may be removed and/or modified without departing from the scope of the computer readable medium 700 disclosed herein. The computer readable medium 700 may be a non-transitory computer readable medium. The term “non-transitory” does not encompass transitory propagating signals.

The computer readable medium 700 may have stored thereon machine readable instructions 702-710 that a processor, such as the processor 102, 402 depicted in FIGS. 1 and 4, may execute. The computer readable medium 700 may be an electronic, magnetic, optical, or other physical storage device that includes or stores executable instructions. The computer readable medium 700 may be, for example, Random Access memory (RAM), an Electrically Erasable Programmable Read-Only Memory (EEPROM), a storage device, an optical disc, and the like.

The processor may fetch, decode, and execute the instructions 702 to determine a first orientation of a first surface portion 310 of a first geological region 302 of a 3D model 300. The processor may fetch, decode, and execute the instructions 704 to determine a second orientation of a second surface portion 314 of the first geological region 302. The processor may determine the first orientation and the second orientation from the orientation information 212 included in a data file 210 of the 3D model 206. In addition, the processor may determine the orientations as angles at which the respective surface portions 310, 314 extend, normal angles 502 of the planes at which the respective surface portions 310, 314 extend, or other suitable orientations.

The processor may fetch, decode, and execute the instructions 706 to determine a first thickness of a first section 312 of the first geological region 302 adjacent to the first surface portion 310 based on the determined first orientation. The processor may fetch, decode, and execute the instructions 708 to determine a second thickness of a second section 316 of the first geological region 302 adjacent to the second surface portion 314 based on the determined second orientation. The second thickness may differ from the first thickness.

According to examples, the processor may identify a second geological region 304 of the 3D model 300, in which the first geological region 302 may completely encompass the second geological region 304. The first geological region 302 and the second geological region 304 may correspond to portions of a 3D part 208 to be fabricated based on the 3D model 206 and the first geological region 302 may be fabricated using a first agent formulation and the second geological region 304 may be fabricated using a second agent formulation. The processor may also determine the first thickness and the second thickness as respective distances from an interface 306 between the first geological region 302 and the second geological region 304.

According to examples, the processor may determine the first thickness and the second thickness from predetermined correlations between a plurality of different orientations of 3D model surfaces and a plurality of thicknesses, in which the predetermined correlations may be selected to cause a 3D part fabricated based on the 3D model to have a consistent optical characteristic, a consistent mechanical property, or both a consistent optical characteristic and a consistent mechanical property across the first surface portion 310 and the second surface portion 314.

The processor may fetch, decode, and execute the instructions 710 to set the first section 312 of the 3D model 300 to have the first thickness and the second section 316 of the 3D model 300 to have the second thickness. In addition, the processor may store the determined first thickness and the determined second thickness in the data store 404. In addition, or alternatively, the processor may communicate the determined thicknesses to the print controller 220 of the 3D fabrication system 200 and the print controller 220 may control components, e.g., the agent delivery devices 238, 240, to fabricate a 3D part 208 according to the determined thicknesses.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, are to cause the processor to:
identify a first orientation of a first surface portion of a first geological region of a three-dimensional (3D) model;
based on the identified first orientation of the first surface portion, determine a first thickness of a first section of the first geological region, the first section being adjacent to the first surface portion, wherein a plurality of different orientations of surface portions are correlated to a plurality of different thicknesses; and
define the first section of the first geological region to have the determined first thickness.

2. The apparatus of claim 1, wherein the instructions are further to cause the processor to:
identify a second orientation of a second surface portion of the first geological region;
based on the identified second orientation of the second surface portion, determine a second thickness of a second section of the first geological region, the second section being adjacent to the second surface portion and the second thickness differing from the first thickness; and
define the second region of the 3D model to have the second thickness.

3. The apparatus of claim 2, wherein the instructions are further to cause the processor to:
identify a second geological region of the 3D model, the first geological region completely surrounding the second geological region, wherein the first geological region and the second geological region correspond to portions of a 3D part to be fabricated based on the 3D model, and wherein the first geological region is to be fabricated using a different agent formulation than the second geological region; and
determine the first thickness and the second thickness as respective distances from an interface between the first geological region and the second geological region.

4. The apparatus of claim 2, wherein the instructions are further to cause the processor to:
identify a second geological region of the 3D model, the first geological region completely encompassing the second geological region, a third section of the second geological region being adjacent to the first section and a fourth geological region of the second geological region being adjacent to the second section;
determine a third thickness of the third section based on the defined first thickness; and
determine a fourth thickness of the fourth section based on the defined second thickness.

5. The apparatus of claim 2, wherein the instructions are further to cause the processor to:
identify the first orientation as a normal angle from an angle at which the first surface portion extends; and
identify the second orientation as a normal angle from an angle at which the second surface portion extends.

6. The apparatus of claim 5, wherein the instructions are further to cause the processor to:
access a lookup table that includes correlations between orientations and thicknesses for the first geological region, wherein the orientations in the lookup table are respectively based on the normal angles of surface portion of the first geological region;
determine the first thickness from the lookup table; and
determine the second thickness from the lookup table.

7. The apparatus of claim 2, wherein a normal angle to the first surface portion extends in a first direction and a normal angle to the second surface portion extends in a section direction that is opposite the first direction and wherein the first thickness is greater than the second thickness.

8. The apparatus of claim 2, wherein correlations between the plurality of orientations of surface portions and the plurality of different thicknesses are to cause a 3D part fabricated based on the 3D model to have a consistent optical characteristic, a consistent mechanical property, or both a consistent optical characteristic and a consistent mechanical property across an exterior surface of the first geological region.

9. A method comprising:
accessing, by a processor, orientation information of a plurality of face portions of a first geological region of a three-dimensional (3D) model;
based on the orientation information, determining, by the processor, for each face portion of the plurality of face portions of the first geological region, a depth at which a corresponding section of the first geological region adjacent to the face portion is to extend from a second geological region of the 3D model, wherein a plurality of the corresponding sections are determined to have different depths with respect to each other; and
defining, by the processor, for each of the face portions, the determined depth of the corresponding section.

10. The method of claim 9, further comprising:
determining the depths at which sections of the first geological region corresponding to the plurality of face portions are to extend from predetermined correlations between a plurality of different orientations of 3D model face portions and a plurality of depths, wherein the predetermined correlations are selected to cause a 3D part fabricated based on the 3D model to have a consistent optical characteristic, a consistent mechanical property, or both a consistent optical characteristic and a consistent mechanical property across the plurality of face portions.

11. The method of claim 9, further comprising:
identifying, from the data file, a second geological region of the 3D model, the first geological region completely surrounding the second geological region, wherein the first geological region and the second geological region correspond to portions of a 3D part to be fabricated based on the 3D model, and wherein the first geological region is to be fabricated using a different agent formulation than the second geological region; and
determining the depths of the first geological region as distances from an interface between the first geological region and the second geological region.

12. The method of claim 11, further comprising:
identifying, from the orientation information for the first geological region, orientations of the plurality of face portions as normal angles from respective angles at which the plurality of face portions extend.

13. A non-transitory computer readable medium on which is stored machine readable instructions that when executed by a processor, cause the processor to:
determine a first orientation of a first surface portion of a first geological region of a three-dimensional (3D) model;
determine a second orientation of a second surface portion of the first geological region;
determine a first thickness of a first section of the first geological region adjacent to the first surface portion based on the determined first orientation;
determine a second thickness of a second section of the first geological region adjacent to the second surface portion based on the determined second orientation, the second thickness differing from the first thickness; and
set the first section to have the first thickness and the second section to have the second thickness.

14. The non-transitory computer readable medium of claim 13, wherein the instructions are further to cause the processor to:
identify a second geological region of the 3D model, the first geological region completely encompassing the second geological region, wherein the first geological region and the second geological region correspond to portions of a 3D part to be fabricated based on the 3D model, and wherein the first geological region is to be fabricated using a first agent formulation and the second geological region is to be fabricated using a second agent formulation, and
determine the first thickness and the second thickness as respective distances from an interface between the first geological region and the second geological region.

15. The non-transitory computer readable medium of claim 13, wherein the instructions are further to cause the processor to:
determine the first thickness and the second thickness from predetermined correlations between a plurality of different orientations of 3D model surface portions and a plurality of thicknesses, wherein the predetermined correlations are selected to cause a 3D part fabricated based on the 3D model to have a consistent optical characteristic, a consistent mechanical property, or both a consistent optical characteristic and a consistent mechanical property across the first surface portion and the second surface portion.
